(19) United States
(12) Patent Application Publication
(10) Pub. No.: US 2006/0226269 A1
(43) Pub. Date: Oct. 12, 2006

(54) Offset disc hammer assembly for a hammermill

(75) Inventor: John C. Stelk, Davenport, IA (US)

Correspondence Address: GODFREY & KAHN S.C., 780 NORTH WATER STREET, MILWAUKEE, WI, 53202, US

(73) Assignee: Riverside Engineering, Inc.

(21) Appl. No.: 11/104,400

(22) Filed: Apr. 12, 2005

(51) Int. Cl. B02C 13/00

(52) U.S. Cl. 241/194

(57) ABSTRACT

A hammer assembly for a hammermill is disclosed. The hammer assembly includes a drive shaft, a plurality of offset discs arranged in axial alignment about the drive shaft, and a plurality of hammers. Each offset disc is placed along the drive shaft adjacent to at least one other offset disc. The arrangement of the discs defines a plurality of alternately offset mounting spaces such that a hammer may be mounted in the offset mounting spaces.

### FIELD OF THE INVENTION

The present invention relates generally to hammermills for shredding scrap materials, and more particularly to an offset disc hammer assembly for a hammermill.

### BACKGROUND OF THE INVENTION

Hammermills for shredding scrap materials such as automobiles are also known as fragmentation machines, and shred or fragment the scrap materials using a hammer assembly including a rotor assembly with a plurality of impact devices such as hammers mounted thereon. The hammer assembly is typically driven by a 2,000-10,000 horsepower (HP) motor at 450-720 revolutions per minute (rpm). Two common hammer assembly configurations in use today include disc assemblies and spider assemblies. The disc assembly generally includes a plurality of discs arranged in spaced-relation about a drive shaft with a plurality of hammers mounted in between the discs. Spacers are typically used in between each disc to create a mounting space for the hammers. One example of a disc assembly is shown in U.S. Pat. No. 4,650,129 to Newell. A spider assembly generally includes a plurality of spider arms mounted about a drive shaft with a plurality of hammers mounted on the ends of the spider arms. One example of a spider assembly is disclosed in U.S. Pat. No. 3,727,848 to Francis and a combination disc-spider assembly is disclosed in U.S. Pat. No. 5,141,167 to Stelk.

Although existing disc assemblies, spider assemblies, and combination disc-spider assemblies have certain benefits and advantages, existing assemblies also have limitations. One limitation associated with existing disc assemblies is that much of the length of the assembly is not used in the shredding process because the hammers cannot be mounted in the same circumferential space as the discs. Rather, the hammers are mounted in the circumferential mounting space created by the spacers in between the discs. One limitation of existing spider assemblies is that the spider arms create inlets in which unshredded materials can become lodged, decreasing the efficiency of the assembly. Likewise, a combination disc-spider assembly does not allow hammers to be mounted in the same circumferential space as the discs, and can also allow unshredded material to become lodged in the inlets created by the spider arms.

Given the limitations associated with the existing assemblies, there exists a need for an improved hammer assembly that allows hammers to be mounted along the entire length of the assembly and prevents unshredded materials from becoming lodged in the assembly. The present invention relates to improvements over the assemblies described above, and to solutions to the problems raised or not solved thereby.

### SUMMARY OF THE INVENTION

The present invention provides an offset disc hammer assembly for a hammermill. The offset disc hammer assembly includes a shaft, a plurality of offset discs arranged in axial alignment about the shaft, and a plurality of hammers. Each disc has a main portion and at least a first offset portion. The discs are arranged about the shaft such that a plurality of first mounting spaces and a plurality of second mounting spaces are defined, wherein the second mounting spaces are offset from the first mounting spaces with respect to the length of the shaft. At least one of the hammers is mounted in one of the first mounting spaces, and at least one of the hammers is mounted in one of the second mounting spaces. The discs are arranged such that each disc is mounted to the shaft adjacent another disc, with each disc preferably being a unitary, single element. The present invention also contemplates a hammermill having an offset disc hammer assembly as previously described.

The present invention has several advantages over existing hammer assemblies for hammermills. Most significantly, the offset disc arrangement allows hammers to be placed across the entire length of the assembly, instead of being spaced apart by the width of the discs. The ability to use the entire length of the assembly creates a more efficient shredding process. In addition, the use of an offset disc assembly instead of a spider assembly or a combination spider-disc assembly reduces the number of parts that need to be assembled, as well as the amount of space available for unshredded materials to become lodged in the assembly. Various other features, objects, and advantages of the invention will be made apparent to those skilled in the art from the accompanying drawings and detailed description thereof.

### BRIEF DESCRIPTION OF THE DRAWINGS

FIG. 1 is a side view of one embodiment of a hammermill including an offset disc hammer assembly according to the present invention;

FIG. 2 is a perspective view of one embodiment of an offset disc hammer assembly according to the present invention;

FIG. 3 is a partially exploded perspective view of the offset disc hammer assembly shown in FIG. 2;

FIG. 4 is a cross-section view of the offset disc hammer assembly of FIG. 2 taken along plane 4-4 of FIG. 2; and

FIG. 5 is a cross-section view of the offset disc hammer assembly of FIG. 2 taken along plane 5-5 of FIG. 2.

### DETAILED DESCRIPTION OF THE INVENTION

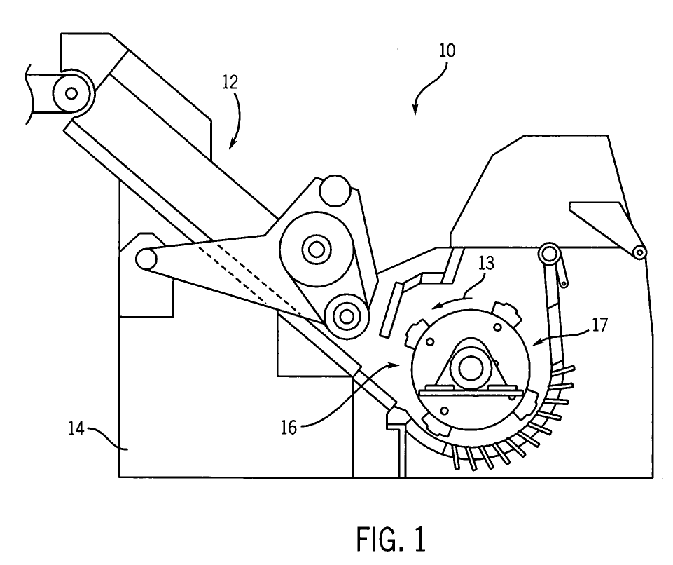

The present invention is an offset disc hammer assembly for use in a hammermill for shredding scrap materials such as automobiles. FIG. 1 shows one embodiment of a hammermill 10 including a hammer assembly 17 according to one embodiment of the present invention. The hammermill 10 has a feed conveyor 12 that delivers materials to be shredded into hammermill housing 14. The housing 14 includes a shredding chamber 16, wherein a hammer assembly 17 is mounted for rotary motion.

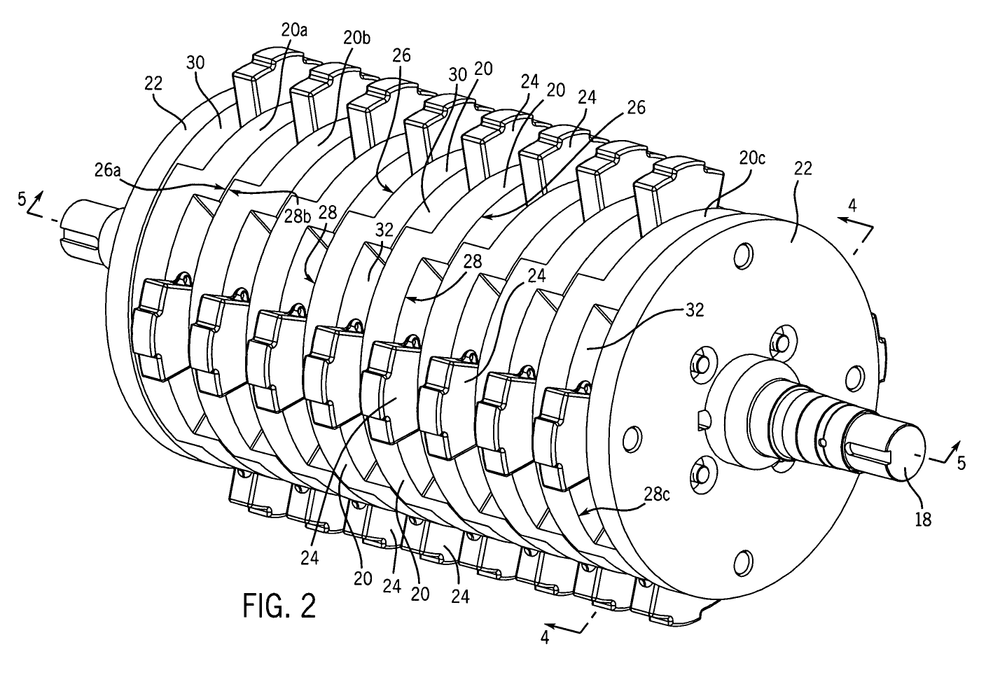

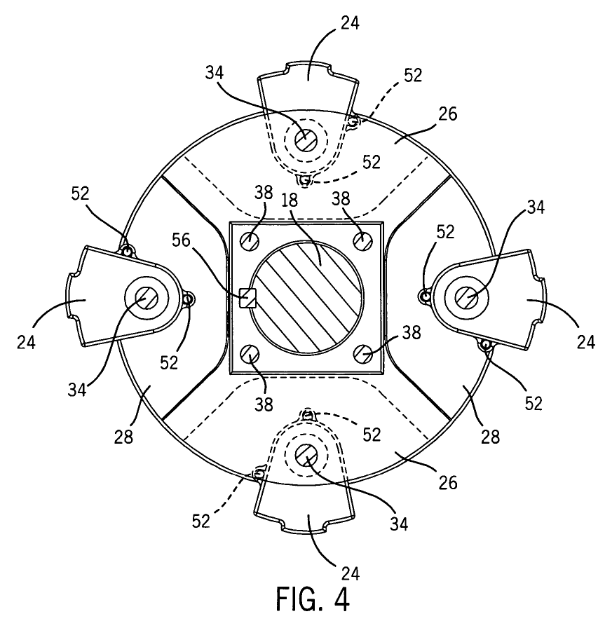

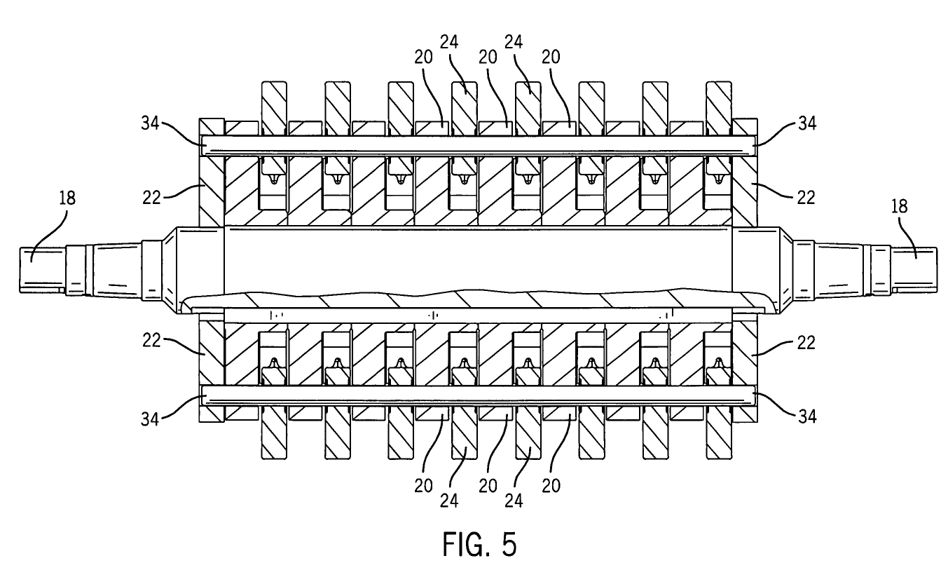

FIGS. 2-5 illustrate one embodiment of an offset disc hammer assembly in accordance with the present invention. For clarity of illustration given the repetitive nature of the assembly, representative parts, as opposed to each of the parts, associated with a particular reference number are labeled in FIGS. 2-5. The hammer assembly 17 includes a shaft 18, a plurality of offset discs 20 arranged in axial alignment along the length of the shaft 18, and a plurality of hammers 24. End discs 22 are also arranged in axial alignment about the shaft 18 at each end of the hammer assembly 17. The shaft 18 engages a motor (not shown) that drives the assembly, as indicated by arrow 13 in FIG. 1. The use of a 2,000-10,000 HP motor capable of driving the assembly at 450-720 rpm has been found to be effective for the shredding of scrap materials such as automobile bodies and the like.

Each offset disc 20 has a main portion 26 and at least one offset portion 28, as shown in FIGS. 2-5. The offset discs 20 are arranged along the shaft 18 such that each disc 20 is adjacent another disc 20. Preferably, each disc 20 is positioned along the shaft 18 such that it is in direct contact with another disc 20. In FIG. 2, for example, the main portion 26a of disc 20a is in contact with the offset portion 28b of disc 20b. The offset discs 20 are also arranged such that a first mounting space 30 is formed between the main portions 26 of adjacent discs 20, and a second mounting space 32 is formed between the offset portions 28 of adjacent discs 20. Further, a first mounting space 30 is formed between the main portion 26a of disc 20a and one of the end discs 22, and a second mounting space 32 is formed between the offset portion 28c of disc 20c and the opposite end disc 22. The second mounting spaces 32 are offset from the first mounting spaces 30, which allows hammers 24 to be mounted in the same circumferential space as the discs 20. In FIG. 2, a hammer 24 is mounted in each of the first mounting spaces 30 and each of the second mounting spaces 32. The hammers 24 do not, however, need to be mounted in each of the first and second mounting spaces 30, 32. For example, the hammers 24 could be mounted in a random fashion in the first and second mounting spaces 30, 32, or in every other first and second mounting space 30, 32, or in all of the first mounting spaces 30 and in a single second mounting space 32. Other hammer mounting configurations could be used as well.

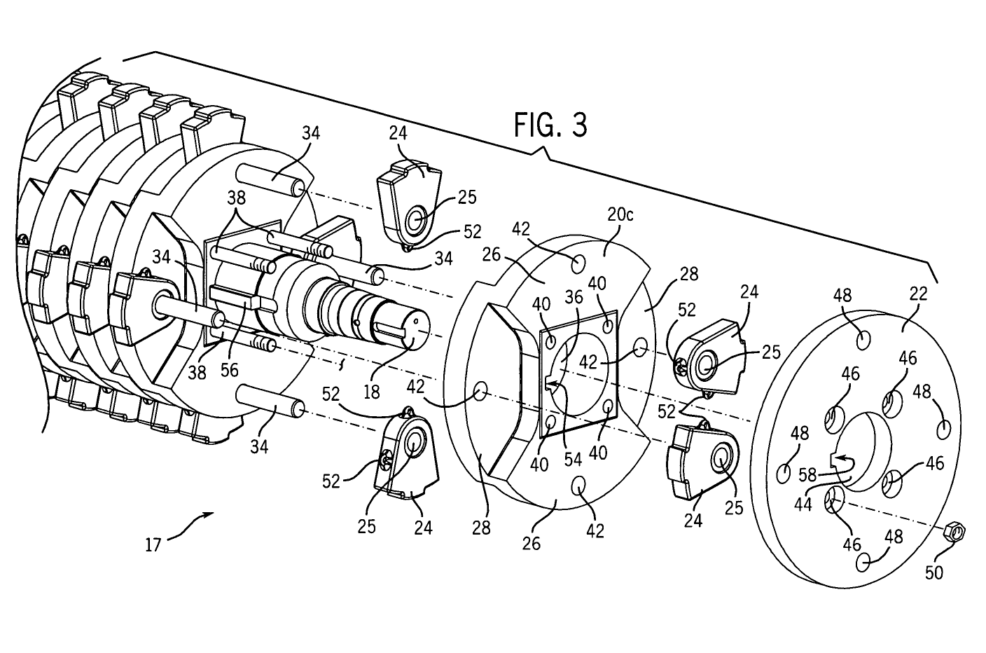

As shown in FIGS. 3-5, disc 20c has main portion 26, two offset portions 28, a center aperture 36 extending through the main portion 26 and including a keyway 54, a plurality of tie rod openings 40 adjacent the center aperture 36, and a plurality of hammer pin openings 42. The disc 20c is inserted on to shaft 18 via center aperture 36 such that the key 56 on the shaft 18, tie rods 38 and hammer pins 34 are aligned with and inserted through the keyway 54, tie rod openings 40 and hammer pin openings 42, respectively. The discs 20 are keyed to the shaft 18 via key 56 and keyway 54 to prevent the discs 20 from rotating relative to the shaft 18 and to align the assembly components properly. A number of other offset disc embodiments could also be used, as the present invention is not limited to the particular embodiment shown and described.

The hammers 24 shown in the figures are substantially U-shaped with an aperture 25 extending through the center of the lower portion of the U-shape. Other hammer shapes and configurations could also be used. Hammers 24 are mounted for rotation about the hammer pins 34 through apertures 25. The hammers 24 shown also include lifting eyes 52 that can be used to hook and lift the hammers 24 with a crane or other lifting device for moving and installation of the hammers 24, however, such features are not particular to the present invention.

As shown best in FIG. 3, end discs 22 also have a center aperture 44 for mounting the end discs 22 on the shaft 18, as well as tie rod openings 46 and hammer pin openings 48 through which tie rods 38 and hammer pins 34 are aligned and inserted. The center aperture 44 of the end discs 22 further includes a keyway 58 to accommodate key 56 on the shaft 18. Fastening nuts 50 can be used in connection with tie rods 38 to secure discs 20 and end discs 22 in place.

In operation, the motor (not shown) rotates the shaft 18. The discs 20 are keyed to the shaft 18, and thus rotate with the shaft 18. As the disc assembly 17 rotates (as indicated by arrow 13 in FIG. 1), the hammers 24 are forced out to the position shown in FIGS. 1-5 by centrifugal forces. In this position, the hammers 24 extend beyond the diameter of the discs 20, 22. Because the hammers 24 are mounted for pivoting about the hammer pins 34, the hammers 24 are able to move relative to the hammer pins 34 in response to impact forces created by the scrap materials being fed through the hammermill. Scrap materials entering the hammermill are thus shredded by the swinging motion of the hammers 24 about hammer pins 34. Using the offset disc hammer assembly 17 of the present invention, more scrap material can be shredded in a shorter amount of time because more hammers 24 can be placed along the length of the assembly 17.

While the invention has been described with reference to preferred embodiments, those skilled in the art will appreciate that certain substitutions, alterations and omissions may be made to the embodiments without departing from the spirit of the invention. Accordingly, the foregoing description and embodiments discussed are meant to be exemplary only, and should not limit the scope of the invention.

What is claimed is:

1. An offset disc hammer assembly for a hammermill, the assembly comprising:
a shaft;
a plurality of discs arranged in axial alignment along the shaft, each disc having a main portion and at least a first offset portion, the discs oriented around the shaft such that a plurality of first mounting spaces and a plurality of second mounting spaces are defined, wherein the second mounting spaces are offset axially from the first mounting spaces; and
a plurality of hammers, at least one of the hammers mounted in one of the first mounting spaces and at least one of the hammers mounted in one of the second mounting spaces.

2. The assembly of claim 1, wherein each hammer is mounted on a hammer pin extending through apertures in the hammers and hammer pin openings in the discs.

3. The assembly of claim 1, wherein each disc is formed as a single piece.

4. The assembly of claim 1, wherein the discs are arranged such that each disc is in direct contact with at least one adjacent disc.

5. The assembly of claim 1, wherein the first mounting spaces are defined between the main portions of adjacent discs.

6. The assembly of claim 1, wherein the second mounting spaces are defined between the offset portions of adjacent discs.

7. The assembly of claim 1, wherein one of the first mounting spaces is defined between a main portion of a disc and a first end disc.

8. The assembly of claim 1, wherein one of the second mounting spaces is defined between an offset portion of a disc and a second end disc.

9. A hammer assembly for a hammermill, the assembly comprising:
a shaft;
a plurality of discs arranged about and along the shaft, each disc in direct contact with at least one adjacent disc, each disc having a main portion and at least one offset portion;
a plurality of first mounting spaces defined between the main portions of adjacent discs;
a plurality of second mounting spaces defined between the offset portions of adjacent discs, the second mounting spaces offset axially from the first mounting spaces; and
a plurality of hammers, at least one of the hammers mounted in one of the first mounting spaces and at least one of the hammers mounted in one of the second mounting spaces.

10. The assembly of claim 9, wherein the hammers are mounted for pivoting about at least one hammer pin.

11. A hammermill comprising:
a housing;
a shredding chamber within in the housing; and
a hammer assembly mounted for rotary motion in the shredding chamber, the hammer assembly comprising a drive shaft, a plurality of offset discs arranged in axial alignment about the drive shaft, each offset disc adjacent at least one other offset disc, the arrangement of the discs defining a plurality of offset mounting spaces, and a plurality of hammers, each hammer mounted in one of the offset mounting spaces.
